(19) United States
(12) Patent Application Publication
(10) Pub. No.: US 2006/0006982 A1
(43) Pub. Date: Jan. 12, 2006

(54) Method And Apparatus For Using RFID's In The Investigation Of Motor Vehicle Accidents

(76) Inventor: Rodney Melvin Gunsauley, Arlington, VA (US)

Correspondence Address: Rodney M. Gunsauley, 4024 North 17th Street, Arlington, VA, 22207, US

(21) Appl. No.: 11/139,487

(22) Filed: May 31, 2005

Related U.S. Application Data
(60) Provisional application No. 60/651,552, filed on Feb. 10, 2005.
(60) Provisional application No. 60/617,631, filed on Oct. 12, 2004.
(60) Provisional application No. 60/575,261, filed on May 29, 2004.

(51) Int. Cl. G05B 19/00; G06F 17/00

(52) U.S. Cl. 340/5.8; 235/375

(57) ABSTRACT

This invention involves the use of an apparatus that would be attached to specific areas of motor vehicles. Contained within this apparatus would be a plurality of (code bearing) radio frequency identifier devices or “RFID's.” Since these codes would be unique to the motor vehicle to which they were assigned; it would now be possible to identify vehicles involved in hit and run accidents by the evidence they would leave behind—in the form of RFID's.

### PRIORITY CLAIM

The present application claims priority to the following: U.S. Provisional Patent Application having Ser. No. 60/651,552 filed on Feb. 10, 2005, U.S. Provisional Patent Application having Ser. No. 60/617,631 filed on Oct. 12, 2004, and U.S. Provisional Patent Application having Ser. No. 60/575,261 filed on May 29, 2004. Parts of which are hereby incorporated by reference.

### FIELD OF THE INVENTION

The present invention relates to the field of accident investigation and reconstruction.

### BACKGROUND OF THE INVENTION

In the past, the collection of evidence at accident scenes has always been piecemeal at best. The present technology is limited to the matching of such items as car parts, paint, etc. in order to determine the make and model of a vehicle.

Additionally, because of the split second time frames (and the trauma that can often be associated with such an event), eyewitness accounts of what transpired can either be unreliable in nature or non-existent.

To solve the above problems, the present invention would employ a novel use of a present technology in the investigation of motor vehicle accidents. The technology referred to in this application is commonly known as “taggants.”

Taggants (i.e. visible or invisible indicia used to mark a product for the purposes of identification and/or verification) are often used for such essential tasks as tracking the shipment of goods, inventory control, document authentication, etc.

By using radio frequency identifier devices or “RFID's” as the above named taggants, it will now be possible to identify drivers who are involved in “hit and run” accidents.

More specifically, by the use of RFID's that would be left at the scene of such accidents, it will now be possible to bring to justice those who commit these “hit and run” crimes. A particularly gratifying use of this invention would be in bringing to justice those who commit the most heinous of these crimes: ones involving personal injury and death.

“Hit and run accidents in the United States have increased fifteen percent over the past five years. On average, motor vehicles are involved in 3.5 million hit and run accidents each year. Hit and run accidents account for one in five pedestrian fatalities . . . ” (From a report compiled by the National Center For Statistics and Analysis and released by the National Highway Traffic Safety Administration on Apr. 22, 2003.)

### SUMMARY OF THE INVENTION

The present invention provides a device that will affix to the front, rear and sides of a motor vehicle; contained within these devices will be a plurality of radio frequency identifier devices or “RFID's.”

It is an object of the present invention that the RFID's contained within these devices be programmed with a single, unique (and encrypted) code that will be proprietary to the motor vehicle to which they are assigned.

It is a further object of the present invention that they perform this function by serving as a “co-identifier” for the vehicle identification (or “vin”) number of the motor vehicle to which they are assigned; vin numbers themselves being unique to each motor vehicle.

It is an object of the present invention that these device holders be composed of a breakable material; causing them to fracture when impacting with another object.

It is a further object of the present invention that this fracturing of the device holder will cause a number of the RFID's (contained within their compartments) to be released.

It is an object of the present invention that the RFID's recovered from the scene of a motor vehicle accident would have their codes compared with their listings in a designated company's proprietary database; this database having been set up for that purpose.

It is a further object of the present invention that the comparing of these codes would yield the following information:

a. the vehicle identification (or “vin”) number of the motor vehicle

b. the year of manufacture of the motor vehicle

c. the make of the motor vehicle

d. the model of the motor vehicle

e. the current state of registration for the motor vehicle

It is a further object of the present invention that the specific state Department of Motor Vehicles provided by the proprietary database be contacted to obtain the identity of the owner.

### BRIEF DESCRIPTION OF THE DRAWINGS

FIG. 1 is an example of a basic RFID system and it's components.

FIG. 2 shows how the RFID's would be “loaded” into the device holder.

FIG. 3 shows the back of a device holder substrate with it's pre-formed adhesive and liner.

FIG. 4 shows an elevation (top) view of a device holder.

FIG. 5 is an exploded view showing all parts of a device holder.

FIG. 6 shows a fractured device holder with the RFID's falling out.

FIG. 7 shows a device holder attached to a vehicle.

FIG. 8 shows a device holder attached to a vehicle with a different design bumper.

FIG. 9 shows an example of a vehicle history report from a website called “AutoCheck.com.”

FIG. 10 shows an RFID system as it would apply to this invention.

FIG. 11 shows an example of a printout from the proprietary database.

### DETAILED DESCRIPTION OF THE PREFERRED EMBODIMENTS

It is to be noted that at the time of this filing, the cost of implementing the system described below would be less than two hundred dollars per vehicle. With experts predicting RFID chips of five cents each in the near future—that cost would then be cut in half.

Types of RFID Tags

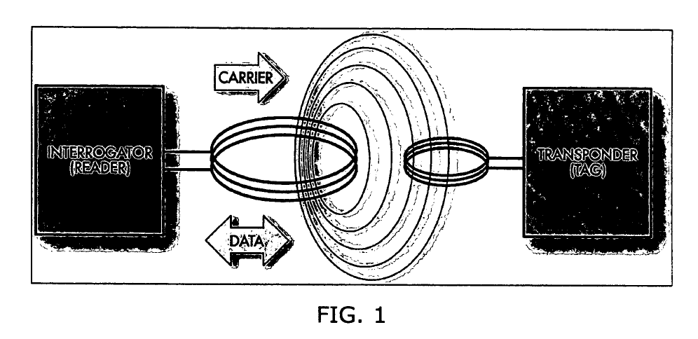

RFID tags are categorized as either active or passive. Active RFID tags are powered by an internal battery; while passive RFID tags operate without a separate external power source and obtain operating power generated from the reader. (See FIG. 1). Passive tags are consequently much lighter than active tags, less expensive, and offer a virtually unlimited operational lifetime.

Pursuant to the present invention, provision is made for passive RFID tags to be used.

Specifics of the Present Invention

RFID Device Holder Design

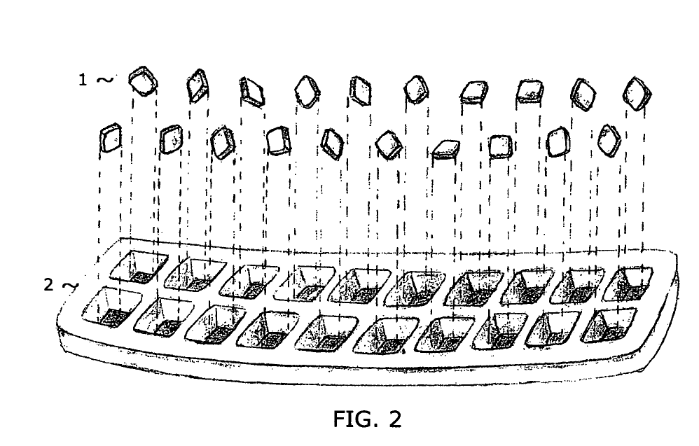

Referring to FIG. 2, the device holder (2) that releases the RFID's (1) would have three parts. The first of which would be a:

Substrate

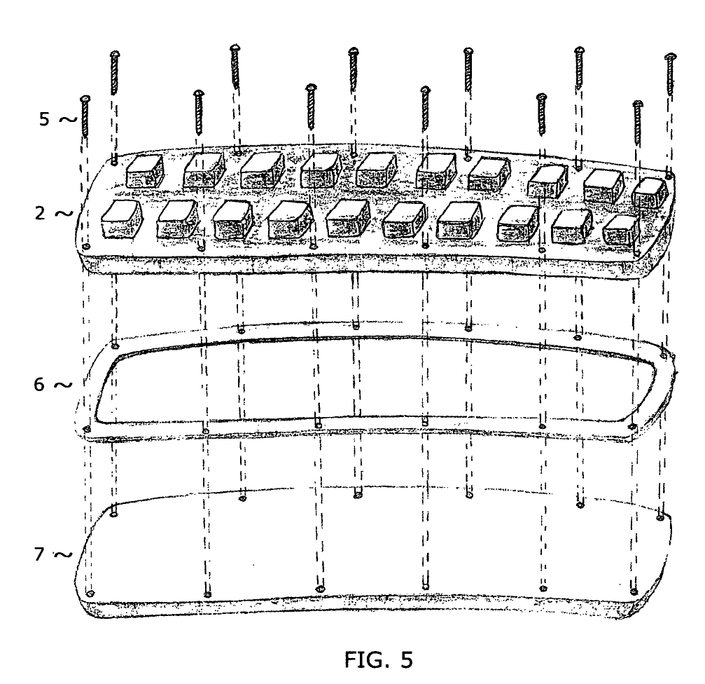

Referring to FIG. 5, the substrate (7) or “base” of the device holder would be typically rectangular in design and made of a flexible material. It would have a length equal to that of the particular motor vehicle to which it is attached; traversing the full length of the front and rear bumpers (or “impact areas”) in order to provide the maximum amount of coverage. Evenly spaced holes along its sides would align it to the other two components of the device holder.

In accordance with a further aspect of the invention, provision would be made for a substrate to be attached to each side of a motor vehicle. Like the others, it too would be rectangular in design and traverse the full length of the motor vehicle.

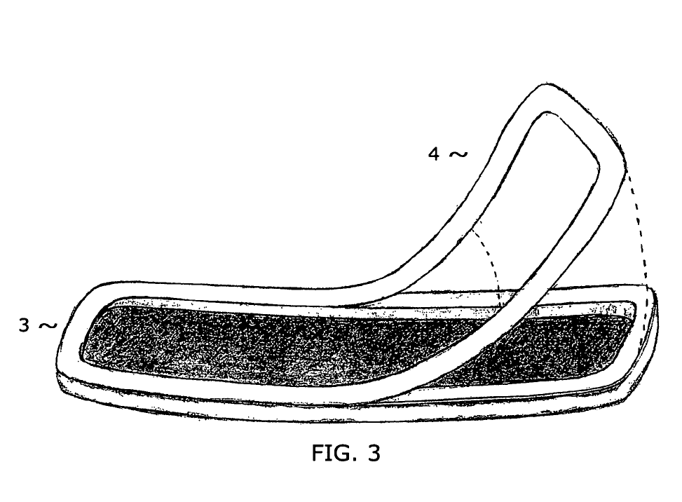

Referring to FIG. 3, the bottom of each substrate would have a pre-formed layer of adhesive (3) attached to its surface. This adhesive strip would have a “cut out” center giving the bottom of the substrate a circumferential border. This layer would be covered by a thin paper strip (4) or “liner”. This protective liner would be peeled back and the substrate attached to the vehicle surface with a uniform pressure fit.

Gasket

Referring again to FIG. 5, a gasket (6) would be used between the substrate (7) and the lens (2) to protect the device holder from moisture and other contaminants. This gasket would be made of a flexible and waterproof material; having the same dimensions as its companion substrate and lens. Evenly spaced holes along its sides would align it to both the substrate and lens.

Lens

Referring again to FIG. 5, the “RFID bearing” lens (2) or “cover” would be made of an opaque colored, breakable material that is sunlight resistant. The inside surfaces would (preferably) be coated with either a fluorescent or an infrared paint to aid in its recovery when fractured. It would have the same length and width as its companion gasket and substrate. Evenly spaced holes along its sides would mate the lens to its base and thus the lens, its underlying gasket and the substrate would be assembled as a single unit.

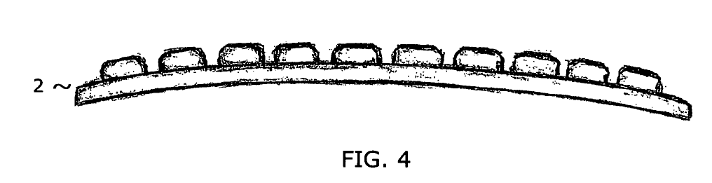

Referring to FIG. 4, an elevation (top) view is shown depicting how the profile of the device holder would protrude out from the surface of the vehicle body.

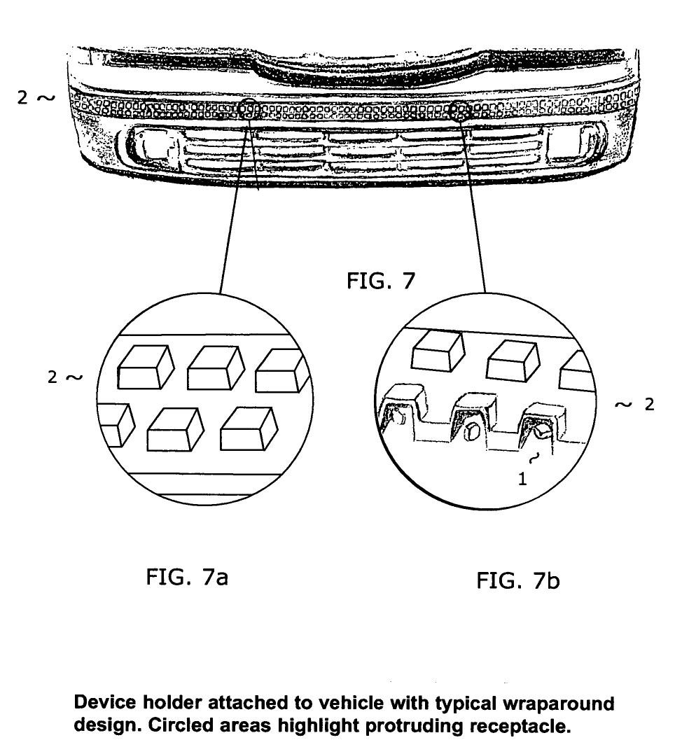

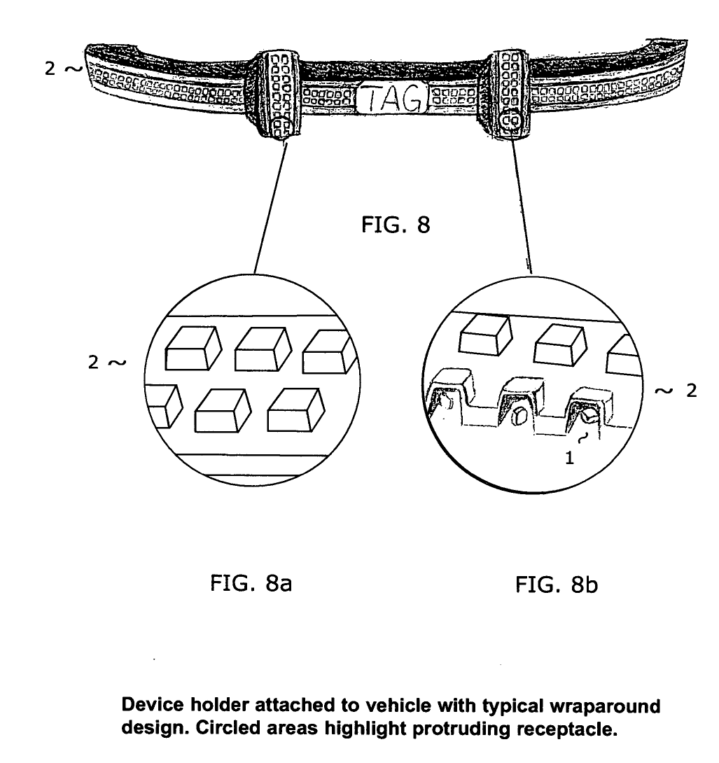

Referring to FIGS. 7 and 8, it can be seen that the lens (2) would have the appearance of an “upside down” ice cube tray. There would typically be two rows of “cubes” (or receptacles) spanning its length. Each cube would contain a single RFID (1) These RFID's would be assembled loose within their compartments to aid in their unrestricted release upon impacting with another object.

Attention is drawn to the fact that FIG. 8 is a representation of a device holder (2) attached to a vehicle with a different design bumper.

Note that in both FIGS. 7 and 8, the sizes of the device holders are for illustrative purposes only. In reality, they would be much smaller (and unobtrusive).

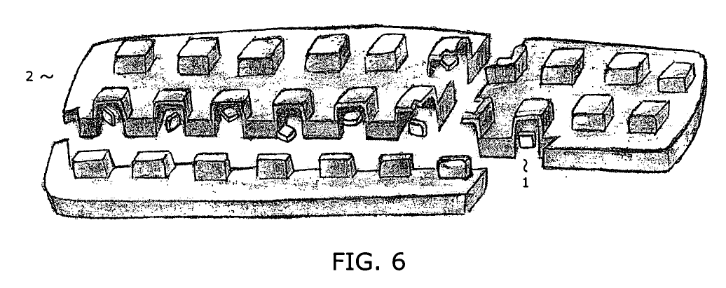

Referring to FIG. 6, a fractured device holder (2) is shown illustrating the RFID's (1) being released.

Due to design considerations (bumpers that become narrow in some areas, for example), it might be necessary to use only one row of cubes instead of the usual two. Also for the same reason, it might be necessary to affix several device holders to the vehicle instead of a single, continuous one. These device holders could either be rectangular or square, once again depending on specific vehicle design.

Referring again to FIG. 5, to prevent tampering by unauthorized personnel, special “tamper resistant” screws (5) with unique heads would be used to assemble the unit. These screws would require the use of a proprietary tool.)

As hereinbefore set forth, the front and rear areas of each motor vehicle would be equipped with its own device holder. In addition, a separate device holder would be attached to each side of a vehicle. The purpose of having device holders in those locations would be to leave evidence behind in a “side swipe” type of accident.

Pursuant to the present invention, provision would be made for device holders to be available from the vehicle's manufacturer and be “make and model specific.” New vehicles would have device holders incorporated within their designs.

Regulation of RFID's and Their Device Holders

In the practice of the present invention, RFID's and their device holders would be issued by local state Departments of Motor Vehicles.

Installation would be done by authorized personnel only. Police could incorporate checks of devices when pulling over motorists for moving violations. It is also suggested that they be examined like motorists are now at so called “sobriety checkpoints” with these unannounced checkpoints being established solely for this purpose. A quick (non-invasive) verification of the coded RFID media could be accomplished with the used of handheld readers (also known as “interrogators”). Inspection of devices could also become a part of the safety inspection for those states having mandatory such inspections at predetermined intervals.

Prohibitive fines could be levied in cases of tampering and/or removal of devices. Drivers who do not report tampering (i.e. broken lens, loss of media, etc.) for any reason could be subject to such large fines.

In carrying out the present invention, it should be noted that an added benefit of having vehicles leave evidence behind (in the form of RFID's), is that drivers would now feel compelled to report having been involved in accidents—regardless of circumstances.

The pre-set shattering (i.e. strength and composition) of the protective lens covers would be established by the appropriate regulatory agencies. This shattering (or separating) pressure to be translated into equivalent miles per hour of impact. Optimally, it will be set above the limits that would normally be associated with a slight impact in order to prevent unnecessary breakage (and subsequent loss of media).

How Code Will Be Assigned:

When a vehicle is sold (or registration information changes for any reason), the appropriate state Department of Motor Vehicles duly lists these changes in their databases.

I propose for this application that all state Department of Motor Vehicles receive bulk quantities of RFID's from a designated company. Along with these devices would be a list (or “range”) of available codes that could be used for programming. Once assigned, this code could not be altered and could only be “unlocked” by a software program furnished by the previously mentioned company.

With the hexadecimal format (16 to the 16^{th} power) that would be used for this code, there are a total of ten quintillion (10,000,000,000,000,000,000) possible code sequences. Individual states could elect to use their assigned code ranges in either a serialized or random manner.

Each motor vehicle registered in that state's database would then receive the required number of these RFID's; with a single (identical) code assigned (i.e. programmed) to them as a whole.

Attention is drawn to the fact that since device holders would be pre-manufactured, the specific number of RFID's required for each vehicle would already be known.

Once assigned, this code would then be entered into a designated company's proprietary database along with the following:

a). The vehicle identification (or “vin”) number of the motor vehicle

b). The year of manufacture for the motor vehicle

c). The make of the motor vehicle

d). The model of the motor vehicle

e). The state of registration for the motor vehicle

(In order for the database to remain current, state DMV's would be required to input new information to it on a regular basis).

Therefore, as has been previously discussed, the unique code contained within the RFID's would act as an identifier for the “vin” number of the vehicle (along with the rest of its information). The entering of this code into the proprietary database would be the first step in locating the driver of the vehicle.

The code would remain with that vehicle and all new vehicle registration information would “update” to that code with the code itself never changing. The issuance of new tags, registration of the vehicle in another state, a change of ownership, etc. would all update to this permanently assigned code. (In the same manner that the above information currently updates to the permanently assigned “vin” number of a vehicle.)

Non-programmable RFID's could also be used. These RFID's would have their codes pre-assigned (i.e. “pre-programmed”) to them at the factory and this code could never be altered.

Each agency would receive it's allotment of devices from the manufacturer and—just as with the programmable ones—would have the option of using their codes in either a serialized or random manner. A segment of these codes would then be assigned to each motor vehicle.

The disadvantages of this particular system would be the assigning of numerous codes (or “identifiers”) for each application; even though they would all lead back to the same vehicle.

How Code Will Be Recovered:

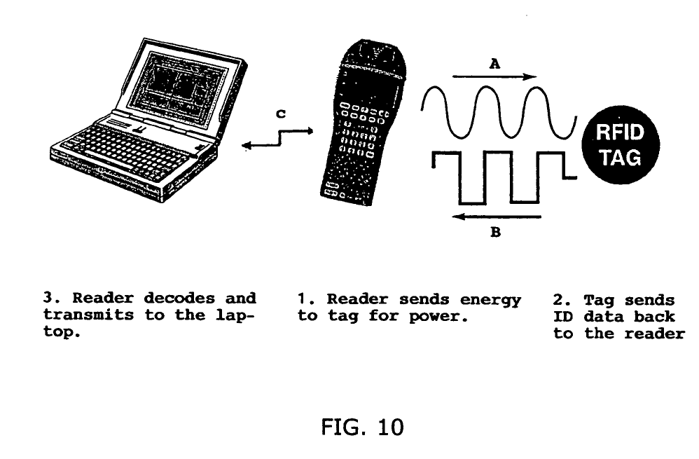

Referring to FIG. 10, the coded information can be obtained in the field with the (previously mentioned) handheld readers or “interrogators”. These units will display the hexadecimal format of the coded sequences on a display screen. These readers will be connected by means of an RS232 port to a laptop computer.

The laptop computer will contain the software program necessary to decode this information; accomplishing this with the use of a “customer specific” algorithm. This algorithm is typically contained within an uncoupler or “chip” located on the computer's motherboard.

How the Owner of the Motor Vehicle Would Be Located:

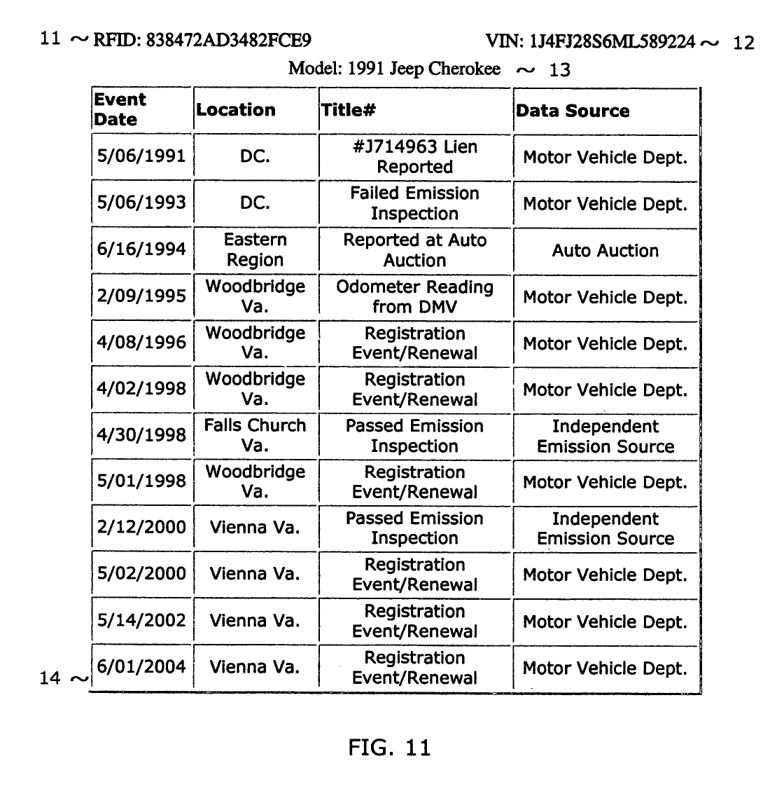

Referring to FIG. 11, When the RFID is retrieved from the accident scene, it's code would then be entered into the designated company's proprietary database. The entering of this code (11) would yield the following information (in a simultaneous manner):

a). The vehicle identification (or “vin”) number of the motor vehicle (12)

b). The year of manufacture for the motor vehicle (13)

c). The make of the motor vehicle (13)

d). The model of the motor vehicle (13)

e). The current state of registration for the motor vehicle (14)

That specific state Department of Motor Vehicles, in this case, “Virginia,” (along with the vehicle's “vin” number), would then be provided to the law enforcement investigator. The contacting of this DMV would lead to the registration information for the motor vehicle—and the identity of the owner.

It should be noted that law enforcement agencies are the only ones who would be able to obtain the above information. It should also be noted that law enforcement agencies would not have access to the proprietary database. These would remain two separate—and distinct—investigative tools.

Pre-Existing Databases:

One skilled in the art will appreciate the fact that a national database of vehicle identification or “vin” numbers for all motor vehicles registered in the United States is currently in use on the internet and is, indeed, available to the general public. Two examples (at the time of this application) are “www.Autocheck.com” and “www.Free-Vin-Checkcom.” These databases list all of the information previously mentioned in paragraph [0074].

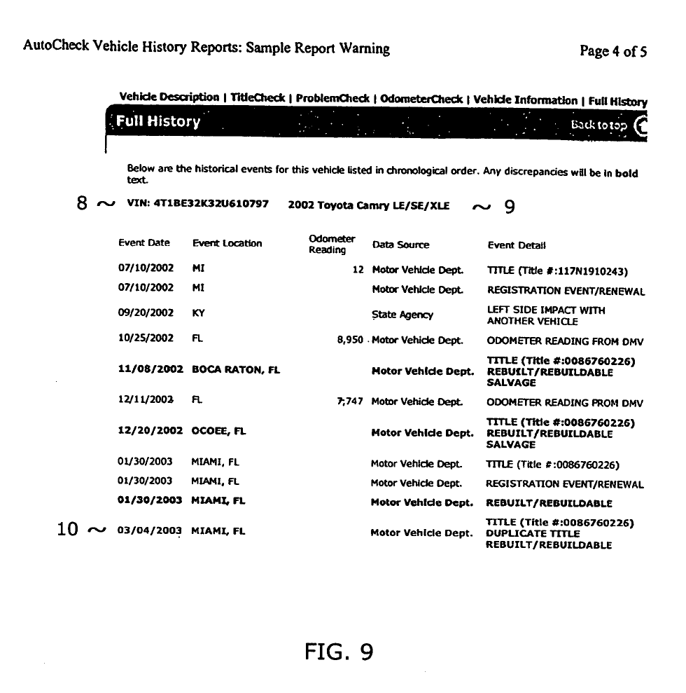

Referring to FIG. 9, a sample download from a website known as “www.AutoCheck.com” is shown. Prospective car buyers wanting to know a vehicle's history would first enter that vehicle's “vin” number (8) into the website's database. Once again, this would yield the following information:

a. The year of manufacture for the motor vehicle (9)

b. The make of the motor vehicle (9)

c. The model of the motor vehicle (9)

d. The current state of registration for the motor vehicle (10)

Attention is drawn to the fact that the matching of an RFID code to it's co-identifying “vin” number in a proprietary database would be the only unique step in this process. The other two steps, the researching of a vehicle's “vin” number in a commercial website's database as well as the matching of a “vin” number to the owner of a vehicle in a particular state DMV registry are already quite common and occur countless times on a daily basis.

It is a feature of the invention that the registration information of a vehicle can be obtained on site; that evidence doesn't need to go thru the time consuming process of being sent to a lab for analysis. This can expedite obtaining the identity of the offender. Quite often those involved in hit and run accidents are not arrested until later (if indeed, ever) and time can be of the essence in determining if someone is under the influence of alcohol or drugs.

While the present invention has been described with reference to what are presently considered to be the embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures.

What is claimed is:

1). A method of:
Identifying motor vehicles involved in “hit and run” accidents by the evidence they would leave behind in the form of radio frequency identifier devices or “RFID's.”

2). The method of claim 1, further comprising the step of:
Having the RFID's mentioned in claim 1 to be both passive and programmable.

3). The method of claim 2, further comprising the step of:
Having every state Department of Motor Vehicles in the United States receive an allotment of these RFID's; whereupon they will assign a specified number of them to each motor vehicle listed in their registries; that number to be determined by the particular make and model of the motor vehicle.

4). The method of claim 3, further comprising the step of:
Having the agencies mentioned in claim 3 act as original (and one time) issuers of these RFID's; meaning their programmed code would remain with that particular motor vehicle for the duration of it's lifetime.

5). The method of claim 4, further comprising the step of:
Having the agencies mentioned in claim 3 program a single, unique (and encrypted) code to the specified number of RFID's that are allocated to a particular motor vehicle; this code then acting as a “co-identifier” for the vehicle identification or “vin” number of that vehicle.

6). The method of claim 5, further comprising the step of:
Having the agencies mentioned in claim 3 compile the following data for each motor vehicle listed in their registries:
a. The RFID code assigned to the motor vehicle
b. The vehicle identification or “vin” number of the motor vehicle
c. The year of manufacture of the motor vehicle
d. The make of the motor vehicle
e. The model of the motor vehicle
f. The current state of registration for the motor vehicle

7). The method of claim 6, further comprising the step of:
Having the agencies mentioned in claim 6 subsequently enter the information (outlined in claim 6) into a proprietary database; this database containing information on every motor vehicle registered in the United States; with additional data being provided by these agencies on a regular basis.

8). The method of claim 7, further comprising the step of:
Having this database set up and maintained by a designated company; this company providing information solely to law enforcement agencies in the course of their investigations.

9). The method of claim 7, further comprising the step of:
Having the RFID codes (contained within the proprietary database) permanently assigned to their designated “vin” numbers; in the same manner that a vehicle identification (or “vin”) number is permanently assigned to a particular motor vehicle for the duration of it's lifetime.

10). The method of claim 7, further comprising the step of:
Having the RFID codes (contained within the proprietary database) available only to authorized personnel of the designated company.

11). A method of:
Having the RFID code(s) recovered at the scene of an accident by law enforcement personnel provided to the designated company.

12). The method of claim 11, further comprising the step of:
After matching the RFID code with its' corresponding data, having the designated company provide this information to the requesting law enforcement agency, whereupon they will contact that specific DMV to obtain the identity of the vehicle's owner.

13). An apparatus for:
Holding a plurality of RFID's assigned to a motor vehicle; “make and model specific” in design, it would affix to the front and rear bumpers or “impact areas” of the motor vehicle for which it is intended.

14). The apparatus of claim 13 wherein:
Another holder (for containing a plurality of RFID's) would be used that would attach to each side of a motor vehicle; extending the fill length (from front to rear) of the vehicle; it's purpose being to leave evidence behind in the event of a “side swipe” type of hit and run accident.

15). The apparatus of claim 13 wherein:
A substrate (or “base”) would be provided for the device holder that would be composed of a flexible material; being “make and model specific” like it's other components; it too would have a design conforming to the specific contours of the motor vehicle for which it is intended. Evenly spaced holes along its sides would mate it to the other components of the device holder.

16). The apparatus of claim 15 wherein:
There would be a layer of moldable adhesive (with a protective paper liner) on the reverse side of the substrate; the purpose of this adhesive being to affix the substrate to the motor vehicle with a uniform pressure fit.

17). The apparatus of claim 13 wherein:
There would be a gasket for the device holder that would be composed of a flexible (and waterproof) material; the purpose of this gasket being to seal out moisture and other contaminants from the contents of the device holder; this gasket fitting between the substrate and the lens (or “cover”) of the device holder. Evenly spaced holes along its sides would mate it to the other components of the device holder.

18). The apparatus of claim 13 wherein:
There would be a lens (or “cover”) for the device holder that would have the appearance of an “upside down” ice cube tray; with each compartment containing a single RFID. Evenly spaced holes along its sides would mate it to the other components of the device holder.

19). The apparatus of claim 13 wherein:
The lens of the device holder would be composed of a sunlight resistant, opaque colored breakable material.

20). The apparatus of claim 13 wherein:
This breakable material, when fractured, would cause the RFID's contained within it to be released.

21). The apparatus of claim 13 wherein:
There would be a specified number of screws for assembling the various components of the device holder (i.e. it's substrate, gasket and lens) into a complete unit; these would be “tamper resistant” screws having unique heads that would require the use of a proprietary tool; the requirement for this tool would act as a deterrent against the tampering of such device holders by unauthorized personnel.

22). The apparatus of claim 13 wherein:
The inside surfaces of the device holder would have the option of being treated with either a fluorescent or an infrared paint in order to facilitate it's recovery at an accident scene when fractured.

23). The apparatus of claim 13 wherein:
The individual RFID's contained within the device holder would have the option of being treated with either a fluorescent or an infrared paint in order to facilitate their recovery from accident scenes as well.

24). The apparatus of claim 13 wherein:
The individual RFID's contained within the device holder would have the option of having a magnetic strip attached to them in order to facilitate their recovery from accident scenes by means of a metal detector.

25). The apparatus of claim 13 wherein:
RFID device holders would be provided to every state Department of Motor Vehicles in the United States by vehicle manufacturers; in the case of new vehicles, manufacturers would have them incorporated in their designs.

26). The apparatus of claim 13 wherein:
Each state Department of Motor Vehicles in the United States would act as original (and one time) issuers of RFID device holders; once assigned they would remain with that motor vehicle for the duration of it's lifetime.

27). A method of:
Using a roadside checkpoint to verify that a motor vehicle's device holders have not been damaged or tampered with and that it contains the (correctly coded) RFID's originally assigned to it; this being accomplished by having the codes compared with their listings in a designated company's proprietary database.

28). The method of claim 27, further comprising the step of:
Using a motor vehicle's safety inspection (that is held at pre-determined intervals) to verify that it's device holders have not been damaged or tampered with and that it contains the (correctly coded) RFID's originally assigned to it; this being accomplished by having the codes compared with their listings in a designated company's proprietary database.

29). A method of:
Assessing the liability of those involved in motor vehicle accidents by the location of RFID's recovered at the scene of an accident; these locations being used to determine the position of said vehicles at their initial points of impact.
